(19) United States
(12) Patent Application Publication
(10) Pub. No.: US 2006/0194908 A1
(43) Pub. Date: Aug. 31, 2006

(54) Colored expandable polystyrene resin having high strength, method for producing thereof, and expandable molded product using the same

(76) Inventors: Sung Ho Baek, Goheung-gun (KR); Bong Keun Ahn, Seo-gu (KR); Keun Hoon Yoo, Yeosu-si (KR); Chan-hong Lee, Yuseong-gu (KR)

Correspondence Address: CANTOR COLBURN, LLP, 55 GRIFFIN ROAD SOUTH, BLOOMFIELD, CT, 06002, US

(21) Appl. No.: 11/338,973

(22) Filed: Jan. 25, 2006

(30) Foreign Application Priority Data
Jan. 25, 2005 (KR) 10-2005-0006729

(51) Int. Cl. C08K 3/26

(52) U.S. Cl. 524/425

(57) ABSTRACT

Disclosed are a colored expandable polystyrene resin having high strength, a method for producing thereof, and an expandable molded product using the same. More specifically, the colored expandable polystyrene resin having high strength of the present invention is characterized in that it is produced by adding nanocalcium carbonate and a colored dye into styrene monomer.

This application claims the benefit of the filing date of Korean Patent Application No. 10-2005-0006729 filed on Jan. 25, 2005 in the Korean Intellectual Property Office, the disclosure of which is incorporated herein in its entirety by reference.

### TECHNICAL FIELD

The present invention relates to an expandable polystyrene resin having a more excellent mechanical strength than conventional expandable polystyrene resins (Hereinafter, referred to as “EPS”), a method for producing thereof and an expandable molded product produced using the resin.

### BACKGROUND ART

In general, EPS is produced using a suspension polymerization by water by adding a polymerization initiator and a foaming agent (for example, hydrocarbon gases such as pentane or butane, or a halogenated hydrocarbon-based foaming agent) into styrene monomer. The expandable polystyrene resin produced thus is in the form of a spherical particle having a diameter of 0.2 to 3.0 mm, and the resultant bead is washed and dried, sieved, and then an expandable molded product was produced.

An expandable molded product of EPS particles may be produced by heating expandable polystyrene resin particles, in which a foaming agent is impregnated into styrene resin, to at least a softening point using vapor, etc. to produce expandable pre-particles in the form of particle having separate bubbles in their insides, followed by further heating the produce expandable pre-particles in a closed mold, which is capable of heating its inside through small holes or slits with vapor, etc., using vapor, etc. to fusion them due to volume expansion of the expandable particles.

The expandable molded product is a resource-saving material whose volume having 98% of air and the remaining 2% of resin. The expandable molded product using EPS has been used for packaging materials of household electrical appliances, boxes for agricultural and marine products, buoyants for farming, insulating materials in housing, etc. since it has excellent properties such as a buffering property, a waterproof property, a thermal property and an insulating property.

In Japanese Patent Application Publication No. 60-31536, the colored dye carbon black was added to confer a coloring property in polymerizing an expandable polystyrene resin. However, the expandable polystyrene resin polymerized thus should be improved sooner or later since its mechanical strength is significantly deteriorated.

Also as a method for improving mechanical strength and a coloring property of an expandable styrene resin using a suspension polymerization, Korean Patent No. 492199 (registered on May 20, 2005) discloses a method in which the density and the thermal conductivity of expandable styrene resin are lowered and its processability is improved in the presence of graphite by conducting a suspension polymerization of styrene, and Korean Patent Application Publication No. 2004-96434 (published on Nov. 11, 2004) discloses a method in which the coloring property, as well as the mechanical property of expandable styrene resin are improved by using a certain ratio of acrylonitrile and styrene monomer and adding a suitable amount of colored dye, but it had not show the satisfactory coloring degree and the satisfactory mechanical strength.

### DISCLOSURE OF INVENTION

The present inventors conducted continuous studies to solve the above-described problems of the colored property expandable polystyrene resin and develop a colored expandable resin having excellent mechanical strength. As a result, they found that a colored expandable resin may be provided, the colored expandable resin having excellent coloring property, as well as very excellent chemical resistance and mechanical strength by adding nanocalcium carbonate particles upon polymerization, and then the present invention was completed.

Therefore, it is an object of the present invention to provide a colored expandable polystyrene resin having excellent mechanical strength.

Also, it is another object of the present invention to provide a method for producing the resin particles, and an expandable molded product produced using the resin particles.

According to one embodiment proposed to achieve the above-described aspect, there is provided a colored expandable polystyrene resin having high strength including a) 100 parts by weight of styrene monomer; b) 0.5 to 5 parts by weight of nanocalcium carbonate; and c) 0.5 to 10 parts by weight of colored dye.

In accordance with another embodiment of the present invention, there is provided a method for producing a colored expandable polystyrene resin having high strength using a suspension polymerization, wherein 0.5 to 5 parts by weight of nanocalcium carbonate and 0.5 to 10 parts by weight of colored dye are added thereto, based on 100 parts by weight of styrene monomer upon polymerization.

Hereinafter, the present invention will be described in detail.

An amount of the used nanocalcium carbonate, used herein, is varied according to desired strength of EPS, but it is desirable to be used in an amount of 0.5 to 5 parts by weight, and preferably 3 to 4 parts by weight, based on 100 parts by weight of the added styrene monomer.

If the nanocalcium carbonate is used in an amount of 0.5 parts by weight or less, the expandable polystyrene resin has a slight effect of improving strength, while if the nanocalcium carbonate exceeds 5 parts by weight, the resin particles may be aggregated during suspension polymerization.

At least one selected from the group consisting of red dye (red color), blue dye (blue color) and black dye (black color) is used as the colored dye, used herein, and an amount of the used colored dye is varied according to desired color concentration, but it is desirable to be used in an amount of 0.5 to 10 parts by weight, and preferably 2 to 5 parts by weight, based on 100 parts by weight of the added entire monomer.

If the colored dye is used in an amount of 0.5 parts by weight or less, the expandable polystyrene resin has a slight effect of improving strength and a significant color difference between the expandable particles, while if the colored dye exceeds 10 parts by weight, the resin particles may be aggregated during suspension polymerization.

The red dye (red color), the blue dye (blue color) and the black dye (black color), used herein, may be used if they are generally used in the art.

As the polymerization initiator, it is advantageous to use an initiator that is dissolved in monomers and has a half-life temperature of 50 to 120° C. for 10 hours. An example of the polymerization initiator includes organic peroxides such as cumene hydroxy peroxide, dicumyl peroxide, t-butyl peroxy 2-ethylhexanoate, t-butyl peroxy benzoate, benzoyl peroxide, lauryl peroxide, etc.; or azo compounds such as azobis isobutylnitrile, etc., and they may be used alone or in combination thereof. The total amount of the used polymerization initiator preferably ranges from 0.01 to 2 parts by weight, based on 100 parts by weight of the added entire monomer.

As a suspension stabilizer used herein, hydrophilic polymers such as polyvinyl alcohol, methyl cellulose, polyvinyl pyrrolidone, etc.; or insoluble inorganic salts such as calcium phosphate tribasic, pyrophosphoric acid magnesium, etc. may be used in the method of the present invention, and, if necessary, be used in combination with surfactants. For example, if the insoluble inorganic salts are used as the suspension stabilizer, then they are preferably used in combination with anionic surfactants such as sodium alkylsulfonate, sodium dodecyl benzene sulfonate, etc. The suspension stabilizer is preferably used in an amount of 0.01 to 5 parts by weight, based on 100 parts by weight of the added entire monomer, and if it is used in combination with the insoluble inorganic salts and the anionic surfactants, then the insoluble inorganic salts and the anionic surfactants are preferably used in amounts of 0.05 to 3 parts by weight and 0.0001 to 0.5 parts by weight, respectively, based on 100 parts by weight of the added entire monomer.

As the foaming agent used herein, foaming agents generally used for producing an expandable styrene resin, namely volatile organic compounds that is gas or liquid at room temperature under a normal pressure and also does not dissolve resin particles may be used in the method of the present invention. An example of the foaming agent includes aliphatic hydrocarbons such as propane, isobutane, normal butane, isopentane, normal pentane, etc.; cyclic aliphatic hydrocarbons such as cyclopentane, cyclohexane, etc.; and halogenated hydrocarbons, etc. The total amount of the used foaming agent ranges from 3 to 15 parts by weight, and more preferably from 3 to 10 parts by weight, based on 100 parts by weight of the added entire monomer. If the amount of the foaming agent is less than 3 parts by weight, then it is difficult to give expandability, while if its amount exceeds 15 parts by weight, then an effect as the foaming agent is not shown any more.

In the method of the present invention, it is possible to add additives generally used for producing an expandable styrene-based resin, for example flame retardants such as hexabromocyclododecane, etc.; flame-retardant formulations such as 2,3-dimethyl 2,3-diphenyl butane, etc.; cell modifiers such as polyethylene wax, silica, etc.; plasticizers, chain transfer agents, etc. upon polymerization of monomers.

The colored expandable polystyrene resin, produced by impregnating the foaming agent, is coated with surface-coating agents through dehydration and drying procedures in the present invention. The surface-coating agents, used herein, may be applied in themselves if they are used for producing an expandable styrene-based resin. For example, the surface-coating agent includes glycidyl tristearate, glycidyl monostearate, zinc stearate, antistatic agents, etc.

Expansion of the colored expandable polystyrene resin particles of the present invention is carried out using vapor, a hot wind, hot water, etc., and a method for expanding an expandable styrene resin may be also applied.

### BEST MODES FOR CARRYING OUT THE INVENTION

Hereinafter, the present invention will be described in detail with reference to examples and comparative examples. The following examples, while indicating preferred embodiments of the invention, are given by way of illustration only, without limiting the spirit and scope of the invention to the following preferred embodiments.

### Example 1

10 kg of styrene monomer was add into a pre-melting bath 1, and 600 g of nanocalcium carbonate (4 parts by weight, based on the amount of the entire added monomer), 450 g of a red dye (red color) Macrolex Red E2G (manufactured by the company Bayer) (3 parts by weight, based on the amount of the entire added monomer), and 15 g of polyethylene wax were added with stirring at 200 rpm, warmed to 60° C., kept for 60 minutes to dissolve the added compounds, and then kept at room temperature to be cooled.

75 g of a polymerization initiator benzoyl peroxide (BPO), 8 g of t-butyl peroxy benzoate, 45 g of dicumyl peroxide, 3.75 g of a cross-linker divinylbenzene (DVB) and 5 kg of styrene monomer were added into a pre-melting bath 2, stirred at room temperature for 30 minutes to be dissolved, and the solution prepared in the pre-melting bath 1 was poured thereto, and then stirred for 30 minutes again.

Separately, 15 kg of pure water was added into a 40 L pressure bath, and 25 g of calcium phosphate tribasic and 5 g of an anionic surfactant sodium dodecyl benzene sulfonate were added thereto to prepare a suspension solution, and the solution prepared in the pre-melting bath was added thereto, and then stirred at 300 rpm for 30 minutes. Then, a reactor was warmed to a temperature of 90° C. and kept to be polymerized until a polymerization rate reaches 70%.

Subsequently, the pressure bath was sealed, and then 1,200 g of pentane was added at a rate of 40 g/min while warming to 110° C. again. After the addition was completed and the temperature is reached to 110° C., the pressure bath was kept for 2 hours, and then cooled to 45° C. to obtain expandable polystyrene resin particles.

The resultant resin particles were dehydrated and their fluidized bed was dried so that moisture of particle surfaces is 0.3% or less, and then sieved according to particle sizes. Among them, the polymerized resin having a particle size of 0.9 mm to 1.0 mm was added into a mixer, and then 500 ppm of polyethylene glycol, 2000 ppm of glycidyl tristearate and 1,000 ppm of zinc stearate were added on the basis of the polymerized resin, and stirred for 20 minutes.

### Example 2

Example 2 was carried out in the same manner as in Example 1 except that 450 g of a blue dye (blue color) Macrolex Blue 3R (manufactured by the company Bayer) (3 parts by weight, based on the entire added monomer) was added as the colored dye in Example 1.

### Example 3

Example 3 was carried out in the same manner as in Example 1 except that 450 g of a black dye (black color) graphite powder (3 parts by weight, based on the entire added monomer) was added as the colored dye in Example 1. It is considered that it may be used as a thermal-insulating material having excellent thermal-insulating property upon use of black dye.

### Example 4

Example 4 was carried out in the same manner as in Example 1 except that 300 g of nanocalcium carbonate (2 parts by weight, based on the entire added monomer) was added in Example 1.

### Example 5

Example 5 was carried out in the same manner as in Example 1 except that 750 g of a red dye (red color) Macrolex Red E2G (manufactured by the company Bayer) (5 parts by weight, based on the entire added monomer) was used as the colored dye in Example 1.

### Comparative Example 1

Comparative example 1 was carried out in the same manner as in Example 1 except that the colored dye was not used in Example 1.

### Comparative Example 2

Comparative example 2 was carried out in the same manner as in Example 1 except that 15 g of a red dye (red color) Macrolex Red E2G (manufactured by the company Bayer) (0.1 part by weight, based on the entire added monomer) was used as the colored dye in Example 1.

### Comparative Example 3

Comparative example 3 was carried out in the same manner as in Example 1 except that 1,800 g of a red dye (red color) Macrolex Red E2G (manufactured by the company Bayer) (12 parts by weight, based on the entire added monomer) was used as the colored dye in Example 1.

### Comparative Example 4

Comparative example 4 was carried out in the same manner as in Example 1 except that 30 g of nanocalcium carbonate used in Example 1 (0.2 parts by weight, based on the entire added monomer) was used in Example 1.

### Comparative Example 5

Comparative example 5 was carried out in the same manner as in Example 1 except that 900 g of nanocalcium carbonate used in Example 1 (6 parts by weight, based on the entire added monomer) was used in Example 1.

### Comparative Example 6

Comparative example 6 was carried out in the same manner as in Example 1 except that the colored dye and nanocalcium carbonate were not used in Example 1.

The expandable molded products produced in Examples 1 to 5 and Comparative examples 1 to 6 were measured for coloring degree, compressive strength and flexural strength, and the results are listed in the following Table 1.

TABLE 1

| | | Amount | Amount | | | |
|---|---|---|---|---|---|---|
| | | of | of Added | | | |
| | | Added | Nano- | | | |
| | | Dye | calcium | | Compres- | Flexural |
| | Kind | (Parts | Carbonate | Color- | sive | Strength |
| | of | by | (Parts by | ing | Strength | (kgf/ |
| Items | Dye | Weight) | Weight) | Degree | (kgf/cm²) | cm²) |
| Example 1 | Red | 3 | 4 | ◯ | 2.1 | 4.5 |
| | Color | | | | | |
| Example 2 | Blue | 3 | 4 | ◯ | 2.1 | 4.6 |
| | Color | | | | | |
| Example 3 | Black | 3 | 4 | ◯ | 2.2 | 4.4 |
| | Color | | | | | |
| Example 4 | Red | 3 | 2 | ◯ | 1.6 | 3.5 |
| | Color | | | | | |
| Example 5 | Red | 5 | 4 | ◯ | 2.0 | 4.5 |
| | Color | | | | | |
| Comparative | Not | 0 | 4 | X | 2.1 | 4.3 |
| example 1 | Used | | | | | |
| Comparative | Red | 0.1 | 4 | Δ | 2.1 | 4.2 |
| example 2 | Color | | | | | |
| Comparative | Red | 12 | 4 | Polymerization Failed | | |
| example 3 | Color | | | | | |
| Comparative | Red | 3 | 0.2 | ◯ | 0.9 | 2.2 |
| example 4 | Color | | | | | |
| Comparative | Red | 3 | 6 | Polymerization Failed | | |
| example 5 | Color | | | | | |
| Comparative | Not | 0 | Not Used | X | 0.9 | 2.1 |
| example 6 | Used | | | | | |

[Method for Measuring Coloring Degree, Compressive Strength and Flexural Strength]

1) Method for Measuring Coloring Degree

A cross section of a molded product was cut, and then coloring levels of expandable particles and their insides were observed.

∘: Excellent, Δ: Slight, X: No coloring property

2) Method for Measuring Compressive Strength and Flexural Strength

Compressive strength and flexural strength were measured according to a JIS A9511 method.

As seen in the table, the coloring property styrene resin according to the present invention had a good coloring degree and a significantly improved mechanical strength.

### INDUSTRIAL APPLICABILITY

As described above, the present invention provides a high-strength colored expandable resin having excellent coloring property, as well as very excellent chemical resistance and mechanical strength since nanocalcium carbonate particles are added thereto upon polymerization.

Although a few embodiments of the present invention have been shown and described, it would be appreciated by those skilled in the art that changes might be made in this embodiment without departing from the principles and spirits of the invention, the scope of which is defined in the claims and their equivalents.

What is claimed is:

1. A colored expandable polystyrene resin having high strength comprising:
a) 100 parts by weight of styrene monomer;
b) 0.5 to 5 parts by weight of nanocalcium carbonate; and
c) 0.5 to 10 parts by weight of colored dye.

2. The colored expandable polystyrene resin having high strength according to claim 1, wherein at least one selected from the group consisting of red dye (red color), blue dye (blue color) and black dye (black color) is used as the colored dye.

3. A method for producing a colored expandable polystyrene resin having high strength using a suspension polymerization as defined in claim 1, wherein 0.5 to 5 parts by weight of nanocalcium carbonate and 0.5 to 10 parts by weight of colored dye are added thereto, based on 100 parts by weight of styrene monomer upon polymerization.

4. An expandable molded product produced from the styrene resin particles having high strength as defined in claim 1.
